(19) United States
(12) Patent Application Publication
(10) Pub. No.: US 2019/0011019 A1
(43) Pub. Date: Jan. 10, 2019

(54) FOOD MACHINE WITH VARIABLE RATIO MECHANISM AND CONTROL SYSTEM

(71) Applicant: ILLINOIS TOOL WORKS INC., Glenview, IL (US)

(72) Inventor: Ruben T. Huerta-Ochoa, Troy, OH (US)

(21) Appl. No.: 16/022,812

(22) Filed: Jun. 29, 2018

Related U.S. Application Data
(60) Provisional application No. 62/528,602, filed on Jul. 5, 2017.

(51) Int. Cl. F16H 3/70; F16H 61/32; A47J 43/08; A47J 43/044

(52) U.S. Cl. CPC F16H 3/70; F16H 61/32; F16H 1/16; A47J 43/044; A47J 43/082

(57) ABSTRACT

A food processing machine includes a head extending over a bowl receiving location, the head including a rotatable output member for receiving a mixer tool. A drive system for effecting rotation of the rotatable output member includes a primary drive motor connected through a variable ratio transmission assembly to drive the output member, and a modulator motor linked to operate the variable ratio transmission assembly.

### TECHNICAL FIELD

This application relates generally to commercial food processing machines such as mixing machines of the type used to mix food products and, more specifically, to a drive system for such machines.

### BACKGROUND

A number of drive arrangements have been employed in food processing machines in the past to facilitate the ability to perform a variety of food preparation and food processing functions by operating at different speeds.

Some existing food preparation machines operate at different speeds as a result of the operator action on a speed change lever, intended to select a speed that is appropriate for a given food processing operation. This type of machine is built with a system of gears, shafts, lever mechanisms and clutch to enable manual shifting of speed as desired by the operator for a particular recipe or food processing function.

Other existing food processing/food preparation machines are built with a variable speed motor and an inverter drive motor controller. This type of machine can operate at a variety of speeds appropriate to perform a diverse set of food preparation and food processing functions. Speed changes can take place automatically and in sequence in order to perform a variety of recipes as desired by the operator. The inverter drive will generate a variable frequency electrical signal that will result in the rotation of the electric motor at the desired speed of operation. This requires minimal need of monitoring by a human operator, and lends itself to programming and automated operation.

Still other existing food processing/food preparation machines are built with a continuously variable transmission and a single speed electric motor. This machine type has the ability to operate at a variety of speeds depending on the specific food processing/food preparation function to be performed. The electric motor is designed to operate at a single speed, and the continuously variable transmission will controllably change the transmission ratio to enable operation at the desired speed that is appropriate for a given food processing/food preparation function. The continuously variable transmission utilizes a pair of adjustable pulleys and a belt connecting these pulleys. The pulleys can be controlled to adjust the transmission ratio as desired.

Each of the foregoing machine types has unresolved issues.

In the case of machines of the type that use a manual lever to change speed of operation, the disadvantages include the inability of the machines to be programmed to perform a desired sequence, and therefore cannot be automated and require constant monitoring by a human operator. The machines also have to stop in order to change the speed, and this is also time consuming. The machines also have a complex construction requiring the assembly of many parts and elements. In particular, the clutch is a machine element operating on the basis of friction, resulting in wear and reliability issues over time. Moreover, the speed of operation may be inconsistent due to the slip effect of the induction motor at high load conditions, potentially resulting in inconsistent food preparation/food processing performance under variable food loads.

Machines of the type that use a variable speed motor and inverter drive have the ability to operate at a desired speed that is optimal for a desired specific food processing or food preparation function. However, this type of machine construction has the disadvantages that include that the inverter drive generates electromagnetic emissions that may be objectionable and/or potentially interfere with operation of other devices nearby unless proper shielding is used. The inverter drive generates undesired harmonics and degraded power factor. The inverter drive is also an expensive component.

Machines of the type built with a continuously variable transmission based on belt and variable pulley system have disadvantages that include that the belt is generally the weak element of the system, requiring regular replacement. Speed control may be inconsistent, as the continuously variable transmission concept can result in inaccurate speed control and inconsistent food processing/food preparation performance.

Accordingly, it would be desirable to provide a food machine drive and control system that addresses one or more of the above issues.

### SUMMARY

In one aspect, a food processing machine includes a head extending over a bowl receiving location, the head including a rotatable output member for receiving a mixer tool. A drive system for effecting rotation of the rotatable output member includes a primary drive motor connected through a variable ratio transmission assembly to drive the output member, and a modulator motor linked to operate the variable ratio transmission assembly.

In another aspect, a food processing machine includes a head extending over a bowl receiving yoke, the head including a rotatable output member for receiving a mixer tool, where the bowl receiving yoke is movable up and down relative to the head. A drive system for effecting rotation of the rotatable output member includes a primary drive motor and a modulator motor. The primary drive motor is operatively connected to an input of a variable ratio transmission assembly, where the variable ratio transmission assembly includes an output operatively connected to drive the output member. The modulator motor is operatively connected to rotate a control wheel of the variable ratio transmission assembly. Rotation of the control wheel in a first direction results in an increase in speed of the output of the variable ratio transmission assembly and rotation of the control wheel in a second direction, opposite the first direction, results in a decrease in speed of the output of the variable ratio transmission assembly.

The details of one or more embodiments are set forth in the accompanying drawing and the description below. Other features, objects, and advantages will be apparent from the description and drawing, and from the claims.

### BRIEF DESCRIPTION OF THE DRAWINGS

FIG. 1 is a perspective view of a food processing machine in the form of a mixer;

FIG. 2 is a perspective view of a drive system of the machine;

FIGS. 3A-3C are views of a variable ratio transmission assembly;

FIG. 4 is a partially exploded view of the variable ration transmission assembly;

FIG. 5 is a view with the variable ration transmission assembly fully exploded; and

FIG. 6 is an exemplary control diagram.

### DETAILED DESCRIPTION

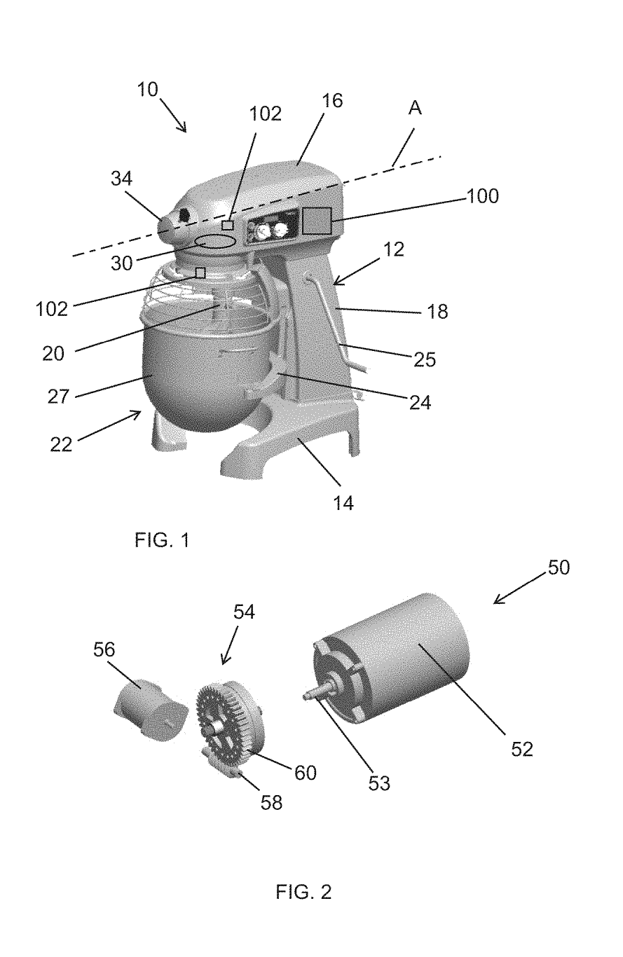

Referring to FIG. 1, an exemplary food processing/preparation machine in the form of a commercial mixing machine 10 is shown. Such a machine typically has a mixer body 12 having a base portion 14, a head portion 16 and a support portion 18 (e.g., in the form of a column) connecting the head and base portions in a vertically, spaced-apart relationship. A front-to-back head portion axis A is shown. An output member 20 (e.g., a shaft for receiving a mixer tool, such as a beater or whip) extends downward from the head portion 16 in a direction toward a bowl receiving location 22 formed between arms 24 of a bowl receiving yoke that can be moved up and down relative to the head portion by rotation of the illustrated handle 25 (or alternatively by a power drive) in order to move the bowl 27 up and down. A bowl guard is also shown. A power take off 34 extends outwardly from a front side of the head portion 16 and may take the form of a protruding hub or boss that is adapted for connection to mixer accessories such as meat grinders, slicers, etc. A machine controller 100 is also shown in schematic form. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the apparatus or the control functions of any component thereof.

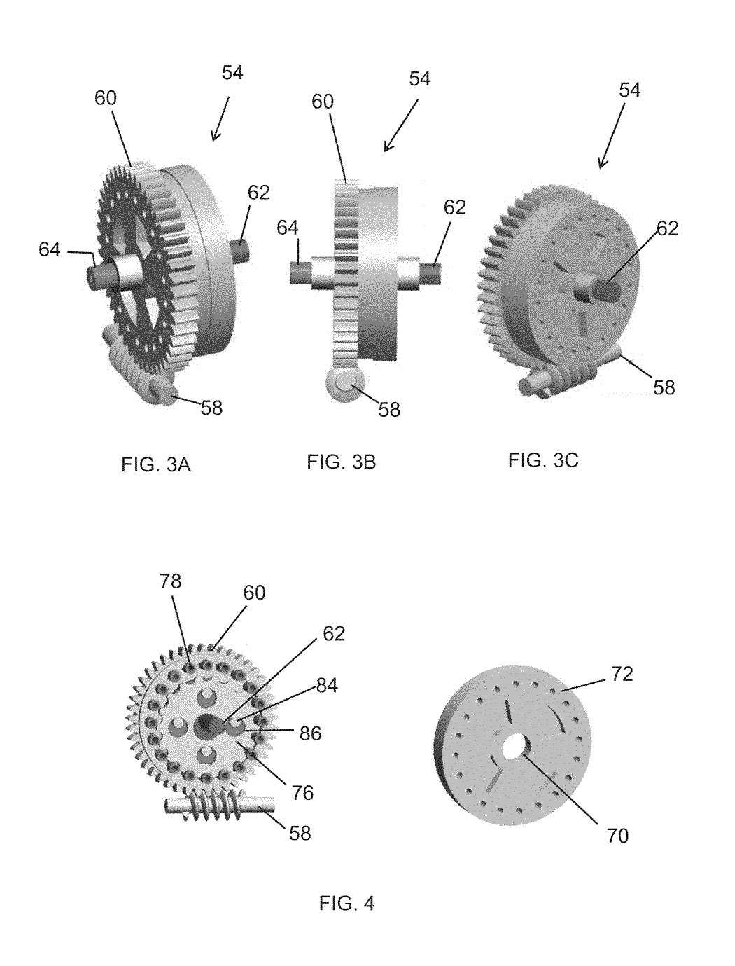

FIG. 2 shows an exploded view of a drive system 50 of the mixing machine 10. The drive system would typically be located internally of the machine body 12. The drive system includes a main drive motor 52 that is linked to the output member 20 for effecting rotation of the output member about a first axis and orbiting movement of the output member and first axis about a second axis (e.g., a planetary movement or planetary rotation via planetary gearing 30 in the mixer head). Here, the motor 52 includes an output shaft 53 that is linked to drive the output member 20 through a variable ratio transmission assembly 54 (shown in larger perspective and elevation views in FIGS. 3A-3C) that is controlled by a modulator motor 56. In particular, the modulator motor 56 rotates a worm 58 that engages a worm wheel 60 that is part of the assembly 54. The output shaft 53 engages and drives an input shaft 62 of the assembly 54, so the rotating speed of the input shaft 62 is the same as the rotating speed of the motor shaft 53. The rotating speed of the output shaft 64 is variable depending upon whether the worm wheel 60 is being rotated, and the speed and direction of worm wheel rotation. Thus, the worm wheel 60 acts as a speed control gear or wheel of the assembly 54. The output shaft 64 is coupled through other structure to the planetary gearing of the mixing machine output member 20.

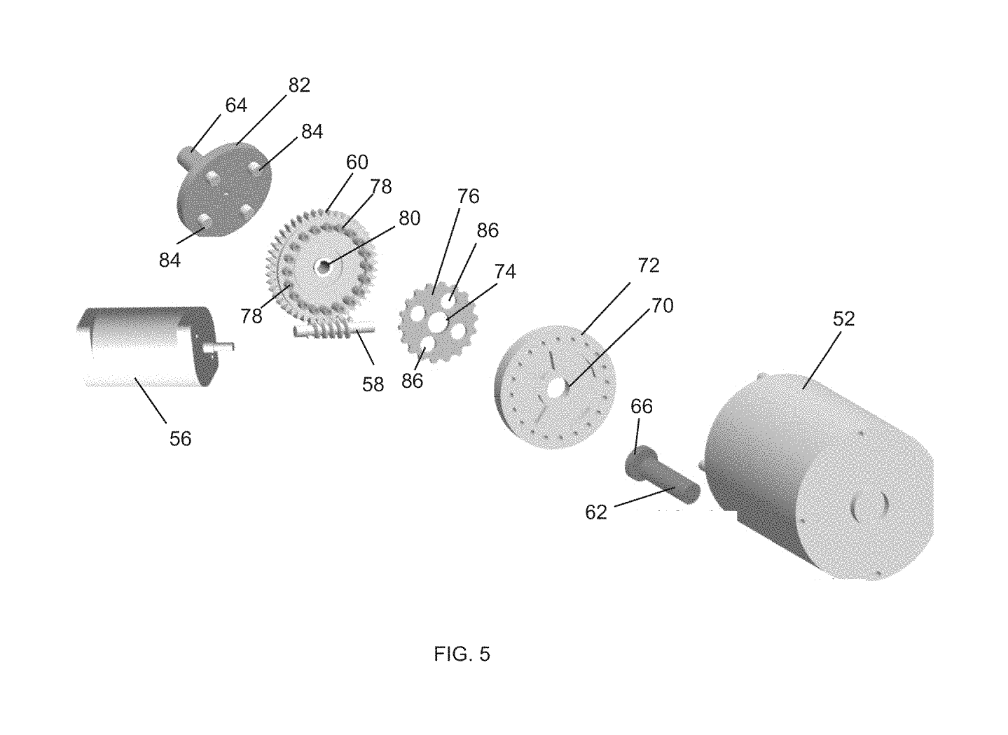

As seen in FIGS. 4 and 5, the variable ratio transmission assembly 54 includes the input shaft 62 that passes through an opening 70 in a front cover 72 of the assembly. The shaft includes an eccentric circular cam plate 66 at the internal end (e.g., the central axis of shaft 62 is offset from a central axis of the cam plate 66), which cam plate is positioned within a central opening 74 of an internal gear 76 that is captured within the assembly. The worm wheel 60 includes an internal side with multiple circumferentially spaced apart bushings or posts 78. The output shaft 64 passes through a central opening 80 of the worm wheel 60 and has a driven plate 82 at the internal end, which driven plate 82 sits against the internal side of the worm wheel within the perimeter defined by the bushings 78. The internal gear 76 sits adjacent the inward facing side of the driven plate 82, with multiple circumferentially spaced posts 84 of the driven plate 82 engaged through multiple corresponding circumferentially spaced openings 86 of the internal gear 76. Notably, the diameter of each opening 86 is larger than the diameter of each post 84. Rotation of input shaft 62 causes the internal gear 76 to orbit within the periphery of the bushings 78 as the tooth structure of the gear 76 rides along the bushings 78, which bushings 78 form an enclosing gear profile. The orbiting of the internal gear causes the driven plate 82 (and thus shaft 64) to rotate as a result of the interaction between the openings 86 and the posts 84. If the motor 52 is operating at a constant speed and the worm is not rotated, meaning worm wheel 60 is not rotated, a constant rotational output speed of the shaft is achieved. However, if the worm wheel 60 is rotated in one direction, the output shaft speed will be decreased, and if the worm wheel is rotated in a second, opposite direction, the output shaft speed will be increased, even if the speed of motor 52 remains constant.

More specifically, the operation of this system is as follows. The motor 52 (e.g., a single speed motor) will operate at constant speed, driving the input shaft 62 and eccentric cam plate 66. The modulator motor 56 will be controlled to operate at a variable speed, clockwise or counterclockwise, or even at zero speed, controlled by a system or machine controller. The modulator motor 56 can, for example, be a small variable speed induction motor, a brushless permanent magnet motor, a stepper motor, or other rotating electric machine capable of operating at a variable speed in response to a control signal.

Equation (1) below shows the basic mathematical relationships of this variable ratio transmission assembly:

OUTPUT_RPM=(INPUT_RPM)(P/L−1)±(MODULATOR_RPM)(N/M) (Eq. 1)

where,

OUTPUT_RPM=the rotating speed of the output shaft 64,

INPUT_RPM=the rotating speed of the input shaft 62,

P=the number of teeth on the orbiting internal gear 76,

L=the number of bushings 78 on the worm wheel housing,

N=the number of threads on the worm 58,

M=the number of teeth on the worm wheel 60, and

The ± sign indicates that the modulator motor speed can be controlled to take place clockwise or counterclockwise.

If the modulator motor speed is set at zero, then:

OUTPUT_RPM=(INPUT_RPM)(P/L−1)

The machine 10 with this drive system 50 has the ability to operate at a variety of speeds to perform diverse food processing and food preparation functions. The machine controller 100 can detect functions and other conditions of the machine and control mixing shaft output speed accordingly.

The proposed drive system may utilize a set of sensors (e.g., 102 in FIG. 1) to detect and/or calculate the angular position, angular speed, and angular acceleration of any of the transmission output shaft 64, the planetary gearing 30 or the food processing/food preparation mechanism shaft 20. The sensor(s) could also detect loading on any drive component, including the primary drive motor 52. In addition to this, a set of control algorithms may be programmed into the system controller 100. For instance, each one of the following listed processing and preparation operations may have a unique control sequence or control algorithm, utilizing a unique angular position/velocity/acceleration/torque sequence over a period of time: kneading, mixing, chopping, blending, grinding, slicing, etc. To achieve this, the set of sensors is deployed to implement a feedback control loop.

Notably, the variable speed operation and control of such a machine 10 is implemented without an inverter drive, resulting in lower cost, better reliability, and lack of electromagnetic noise, harmonics, and interference characteristic of inverter drive operation. The number of gears is reduced, and the overall construction of the transmission results in a set of two shafts with only one gear, and one worm, with the motor rotation collinear and aligned with the food preparation mechanism rotation. This arrangement can reduce the number of gears down from four in existing food preparation and food processing machines, and the number of shafts may be reduced from four in existing machines, down to two. This construction also reduces the number of bearings required to support the transmission, and simplifies the geometry of the housing required to support the transmission system.

The machine 10 with drive system 50 also allows for speed control that can deliver a wide range of control performance, including fast and slow ramp up, fast and slow ramp down, and consistent speed control of the food processing mechanism regardless of the torque load. Precise speed control intended to deliver consistent food processing recipe execution for superior results, regardless of the mechanical load imposed by the food material during the food processing function is possible. If the mechanical load is significant, the operation of the motor 52 can result in reduced speed and increased “slip”. The subject drive system will sense the reduction in speed, and compensate for it to bring the system back to a desired speed set point by increasing the speed of the modulator motor 56 and injecting more power to the transmission.

Such a machine 10 with drive system 50 also obviates the need for gear sets and other speed shifting mechanisms required to change speed in food processing machines of the prior art, producing a smooth transition of speeds from set point to set point, with the desired ramping or acceleration rates intended to improve the food processing/food preparation function. An additional advantage of this drive/transmission is that it is not reversible. This attribute means that, whereas either the modulator motor 56 or the single speed motor 52 can effectively drive the food processing mechanism through the output shaft 64, the output shaft 64 cannot effectively force the rotation of the electric motor 52 backwards or the modulator motor 56 backwards. This attribute results in a quick ramp down of speed as soon as either one or both motors (modulator motor or single speed motor) loses electrical power.

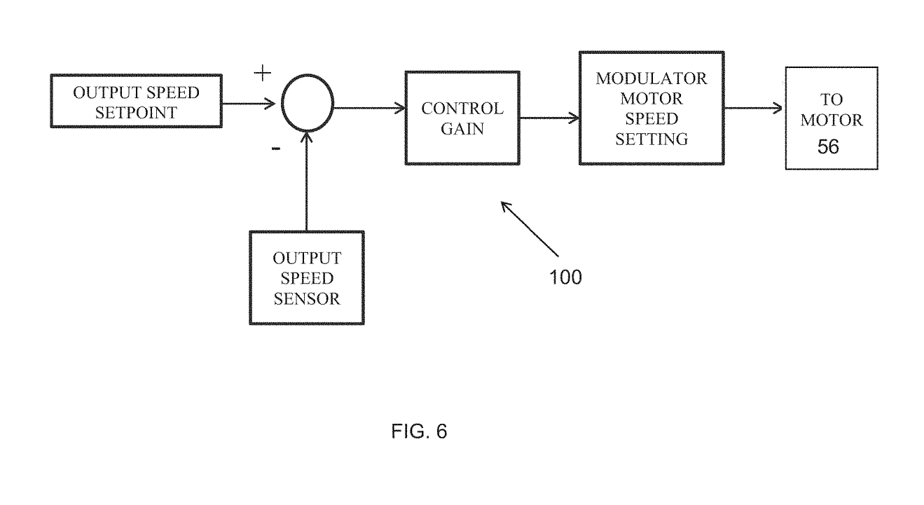

Per the high level control diagram 110 of FIG. 6, the controller 100 can control the speed of the modulator motor 56 so that the output speed can be equal to a desired speed set point (fixed or varying over time for the operation) appropriate for a determined food processing or food preparation function. To achieve the desired speed, the modulator motor 56 may be controlled by the controller 100 according to a predetermined speed profile appropriate for a specific food processing or food preparation function. Alternatively, the illustrated output speed input could be load input of any component in the drive chain, including the motors.

It is to be clearly understood that the above description is intended by way of illustration and example only, is not intended to be taken by way of limitation, and that other changes and modifications are possible.

What is claimed is:

1. A food processing machine, comprising:
a head extending over a bowl receiving location, the head including a rotatable output member for receiving a mixer tool;
a drive system for effecting rotation of the rotatable output member, the drive system including a primary drive motor connected through a variable ratio transmission assembly to drive the output member and a modulator motor linked to operate the variable ratio transmission assembly.

2. The food processing machine of claim 1 wherein:
the primary drive motor includes an output shaft,
the variable ratio transmission assembly includes an input shaft coupled to the output shaft, the input shaft includes an eccentric cam within the variable ratio transmission assembly, where the eccentric cam is engaged to move an internal orbiting gear of the variable ratio transmission assembly, wherein the orbiting gear orbits relative to a control gear of the variable ratio transmission assembly, and the modulator motor is linked to effect rotation of the control gear.

3. The food processing machine of claim 2 wherein a plane of the orbiting gear and a plane of the control gear are parallel to each other.

4. The food processing machine of claim 3 wherein a face of the control gear includes a plurality of circumferentially spaced bushings that interact with a peripheral gear profile of the orbiting gear as the orbiting gear orbits within a perimeter defined by the circumferentially spaced bushings.

5. The food processing machine of claim 2 wherein the control gear is a worm wheel and the modulator motor drives the worm wheel through an associated worm.

6. The food processing machine of claim 2 wherein an output shaft of the variable ratio transmission assembly is coupled to an output plate internal of the variable ratio transmission assembly, wherein the output plate includes a plurality of pins passing through respective holes in the orbiting gear and orbiting movement of the orbiting gear rotates the output plate and the output shaft of the variable ratio transmission assembly.

7. The food processing machine of claim 1, further comprising:
a controller coupled for controlling the primary drive motor and the modulator motor, the controller configured to effect single speed operation of the primary drive motor and single speed rotation of an input shaft of the variable ratio transmission assembly, wherein the controller is further configured to vary a speed of the modulator motor in order to control a speed of an output shaft of the variable ratio transmission assembly.

8. The food processing machine of claim 7 further comprising at least one sensor providing an input to the controller.

9. The food processing machine of claim 8 wherein the sensor is a speed indicator and the controller is configured to control the modulator motor to achieve a set speed for the output shaft of the variable ratio transmission assembly or a set speed for the output member.

10. The food processing machine of claim 7 wherein the controller is configured to define a speed of the modulator motor according to a type of food processing operation being carried out by the machine.

11. The food processing machine of claim 7 wherein the controller is configured to vary a speed of the modulator motor according to a food processing profile stored in memory of the controller.

12. The food processing machine of claim 8 wherein the sensor is a load sensor and the controller is configured to control the modulator motor to maintain a defined load setting or to achieve a defined load profile.

13. The food processing machine of claim 1 wherein the drive motor is a single speed motor and the modulator motor is a multi-speed motor.

14. A food processing machine, comprising:
a head extending over a bowl receiving yoke, the head including a rotatable output member for receiving a mixer tool, the bowl receiving yoke mounted for movement up and down relative to the head;
a drive system for effecting rotation of the rotatable output member, the drive system including a primary drive motor and a modulator motor, the primary drive motor operatively connected to an input of a variable ratio transmission assembly, the variable ratio transmission assembly including an output operatively connected to drive the output member, wherein the modulator motor is operatively connected to rotate a control wheel of the variable ratio transmission assembly, wherein rotation of the control wheel in a first direction results in an increase in speed of the output of the variable ratio transmission assembly and rotation of the control wheel in a second direction, opposite the first direction, results in a decrease in speed of the output of the variable ratio transmission assembly.

15. The food processing machine of claim 14 wherein the primary drive motor is a single speed motor and the modulator motor is a multi-speed motor.

16. The food processing machine of claim 14, further comprising:
a controller coupled for controlling the primary drive motor and the modulator motor, wherein the controller is configured to vary a speed of the modulator motor in order to vary a speed of the output of the variable ratio transmission assembly.

17. The food processing machine of claim 16 further comprising at least one sensor providing an input to the controller.

18. The food processing machine of claim 17 wherein the controller is configured to control the modulator motor to achieve at least one of (i) a set speed for a component at an output side of the variable ratio transmission assembly, (ii) a defined speed profile for a component at an output side of the variable ratio transmission assembly, (iii) a defined load setting for a component, or (iv) a defined load profile for a component.

19. The food processing machine of claim 14 wherein the variable ratio transmission assembly includes an internal gear with a peripheral gear profiled that engages with an enclosing gear profile as the internal gear orbits.
